(19) United States
(12) Patent Application Publication
(10) Pub. No.: US 2009/0300197 A1
(43) Pub. Date: Dec. 3, 2009

(54) Internet Protocol Communication System, Server Unit, Terminal Device, and Authentication Method

(75) Inventors: Yoshimichi Tanizawa, Yokohama-shi (JP); Tsutomu Shibata, Hino-shi (JP); Naoki Esaka, Yokohama-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/472,261

(22) Filed: May 26, 2009

(30) Foreign Application Priority Data
May 27, 2008 (JP) 2008-138394

(51) Int. Cl. G06F 15/173

(52) U.S. Cl. 709/229

(57) ABSTRACT

According to one embodiment, there is provided an Internet Protocol communication system provided with terminal devices configured to mutually communicate with one another via an IP network and a server unit which performs digest authentication in response to authentication requests transmitted from the terminal device. The server unit comprises an authentication processing module which transmits challenge values to terminal devices of authentication request sources, and verifies response values returned to the challenge values, and a determination module which determines results of the digest authentication on the basis of the results of the verification. At least one of the terminal devices comprises an authentication client module which generates the response values by using a defined algorithm in accordance with user passwords input by users, and with device passwords stored in advance, and returns the response values to the server unit.

### CROSS-REFERENCE TO RELATED APPLICATIONS

This application is based upon and claims the benefit of priority from Japanese Patent Application No. 2008-138394, filed May 27, 2008, the entire contents of which are incorporated herein by reference.

### BACKGROUND

1. Field

One embodiment of the present invention relates to an Internet Protocol (IP) communication system which forms sessions among terminals by using Session Initiation Protocol (SIP), and a server unit, a terminal device and an authentication method for use in the system.

2. Description of the Related Art

As regards recent communication systems processed into the IP, forming sessions among terminals by using SIP have become mainly used. So-called Voice over IP (VoIP) systems, which use IP networks and perform voice communication, are representative communication systems. In this kind of systems, users are required authentication through passwords for using terminal devices. The users who can login to the systems through user authentication may extract telephone directory data for their exclusive uses to terminal devices of login sources and may use the data. In recent years, controlling various kinds of processing such as authentication and call connections by using SIP has become widespread.

In SIP (RFC 3261), using Digest Authentication defined fin the extended specifications (RFC 2069) of the Hypertext Transfer Protocol (HTTP) is defined in the Internet Engineering Task Force (IETF) standards.

Performing the user authentication enables providing a unique function for each user, and enables providing fine services. Pushing ahead this way and enabling individually authenticating terminal devices is a possible approach. Combining the user authentication with device authentication enables providing, for example, a service corresponding to identification (ID) and the kind of the device for each user, and improves the convenience.

However, standard digest authentication is limited to perform the user authentication, and does not support the device authentication. Therefore, to achieve the two kinds of authentication, it is necessary to mount or devise, for example, combine a result of the digest authentication of standard SIP with an authentication result of device authentication protocol (IEEE 802.1X, etc.) other than SIP (refer to, e.g., Jpn. Pat. Appln. KOKAI Publication No. 2007-221481). Thereby, overheads of mounting and processing increase, and it is hard to permit a SIP service to a standard SIP terminal which is only corresponds to the digest authentication of standard SIP.

As mentioned above, in the SIP communication system using SIP, further improvements are required in order to perform the device authentication.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary system view depicting an embodiment of an IP communication system of the invention;

FIG. 2 is an exemplary functional block diagram depicting an embodiment of an IP telephone set 11 of FIG. 1;

FIG. 3 is an exemplary functional block diagram depicting an embodiment of a server unit 10 of FIG. 1;

FIG. 4 is an exemplary view depicting an example of a user authentication database 14a;

FIG. 5 is an exemplary view depicting an example of a device authentication database 14b;

FIG. 6 is an exemplary view depicting a message sequence transmitted and received between and IP terminals and the server unit 10;

FIG. 7 is an exemplary flowchart depicting a processing procedure of the ISP telephone set 11 in the sequence of FIG. 6; and

FIG. 8 is an exemplary flowchart depicting a processing procedure of the server unit 10 in the sequence of FIG. 6.

### DETAILED DESCRIPTION

Various embodiments according to the invention will be described hereinafter with reference to the accompanying drawings. In general, according to one embodiment of the invention, there is provided an Internet Protocol communication system provided with terminal devices configured to mutually communicate with one another via an IP network and a server unit which performs digest authentication in response to authentication requests transmitted from the terminal device. The server unit comprises an authentication processing module which transmits challenge values to terminal devices of authentication request sources, and verifies response values returned to the challenge values; and a determination module which determines results of the digest authentication on the basis of the results of the verification. At least one of the terminal devices comprises an authentication client module which generates the response values by using a defined algorithm in accordance with user passwords input by users, and with device passwords stored in advance, and returns the response values to the server unit.

By taking such measures, a terminal device at an authentication request source generates a response value in which device passwords are uniquely assigned to terminal devices, in addition to a user password for each user, by using a challenge value which has been given from a server unit. Authenticating by using the response value enables performing not only user authentication but also device authentication to the terminal devices through one message (response value) Therefore, it makes it possible to easily perform device authentication without a necessity of a complicated message sequence for the device authentication.

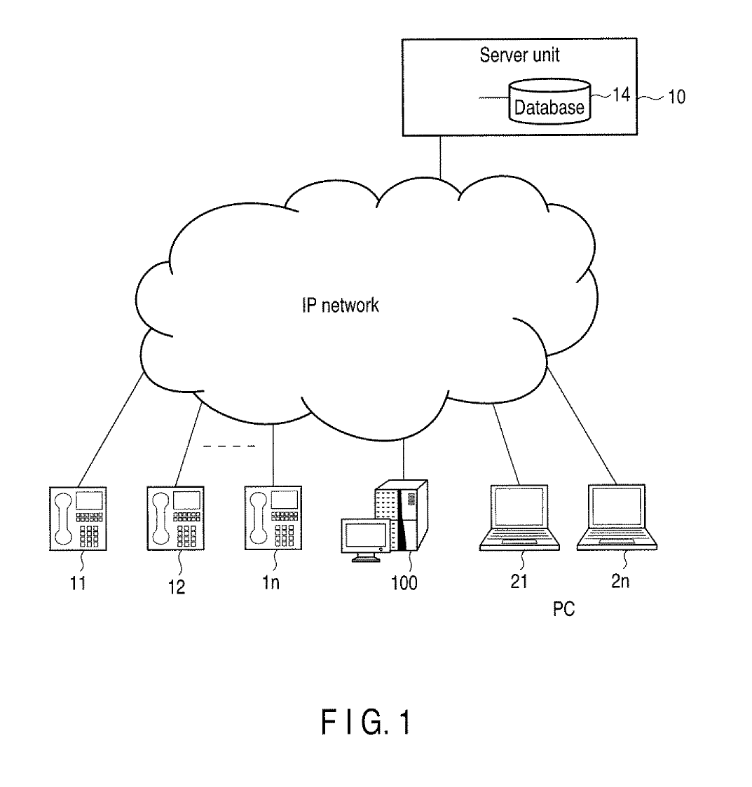

According to an embodiment, FIG. 1 shows a system view depicting an embodiment of an IP communication system of the invention. In this system, a plurality of IP telephone sets 11-1n, a plurality of personal computer (PC) terminals 21-2n, a software-implemented-telephone terminal 100 (referred to as an IP terminal altogether), and a server unit 10 are connected to one another via an IP network. The server unit 10 controls mutual extension speech communication among IP terminals and call connection process of outside-line speech connection to a public network. The server unit 10 receives SIP messages from the IP terminals, and deals with addresses management and routing of telephone calls.

Especially, the system of FIG. 1 controls various services of session formation, presence management and speech communication by using SIP. This system requires authentication for using the IP telephone terminals 11-1n and the software-implemented-telephone terminal 100. When the authentication has completed successfully, address information (SIP URI, IP address, etc.) of the IP telephone sets which have required the authentication and telephone numbers are registered in the server unit 10. The server unit 10 associates address information and telephone numbers of each of the IP telephone sets with one another to manage them in a database unit 14.

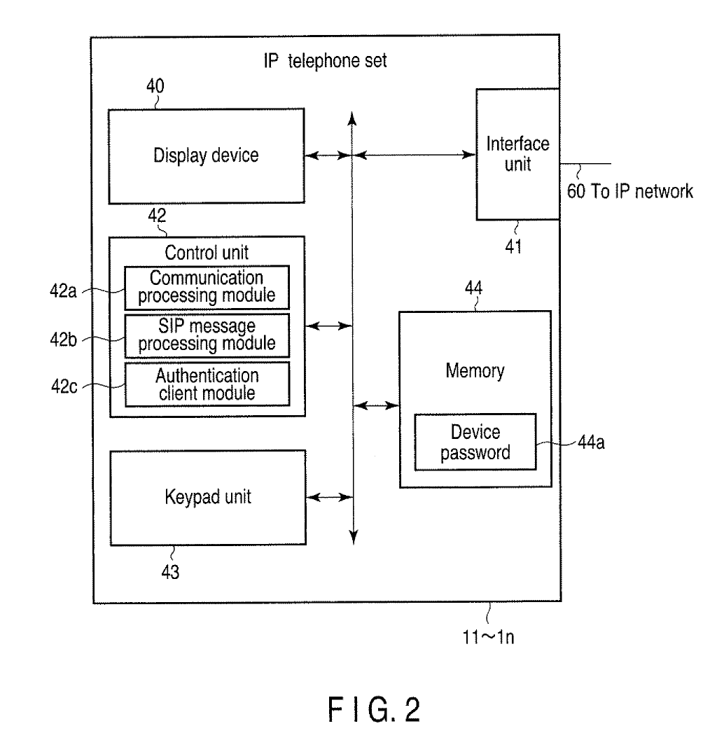

According to an embodiment, FIG. 2 shows a functional block diagram depicting an embodiment of the IP telephone set 11 of FIG. 1. Other IP terminals have the same configuration. The IP telephone set 11 is provided with an interface unit 41 connected to an UP network via a LAN cable 60, a display unit 40, a control module 42, a keypad module 43 and a memory 44. The display device 40 is a liquid crystal display (LCD), and displays various messages. The keypad module 43 includes software-implemented-keys, numeric figure keys, special keys, etc., and receives input operations by a user.

The memory 44 is, for example, a rewritable semiconductor storage device such as a flash memory. In addition to various items of connection information (IP address, etc.) needed for connecting to the server module 10, the memory 44 stores a device password 44a uniquely assigned to a self device, namely the IP telephone set 11.

The control unit 42 includes a communication processing module 42a, a SIP message processing module 42b, and authentication client module 42c as processing functions of the invention. The communication processing module 42a controls communication via the IP network to and from the server unit 10 or other IP terminals. For instance, the module 42a transfers a SIP message received via the IP network to the SIP message processing module 40b, and transmits the SIP message transferred from the module 42b to the IP network.

The module 42b generates and reads the SIP messages. The module 42b performs the operations in accordance with the specifications of User Agent (UA) of SIP described in RFC 3261, etc. The SIP messages are generated by using event occurrences, such as input operations by the keypad unit 43, as triggers. Content items of the SIP messages are read, for example, by using the reception of the SIP messages by the communication processing module 42a as triggers, the result is displayed, for example, on the display unit 40 to notify the result to the user.

The authentication client module 42c provides a function of making the IP terminal and its user request authentication to the server unit 10 and receive the result. That is, the module 42c generates authentication information on the basis of the SIP messages notified from the SIP message processing module 42b and of the information stored in the IP terminal itself. These items of the information may be those of information stored in the memory in advance, or may be information input by means of the keypad operations by the user. The module 42c transfers the generated authentication information to the SIP message processing module 42b. The module 42c transfers the information which is necessary for the authentication processing to the module 42b in response to the read results of the SIP messages.

Especially, the module 42c generates a response value in accordance with an encryption operation including the device passwords 44a in addition to the challenge values and the user passwords transmitted from the server unit 10 for the authentication processing. The encryption operation may use the existing algorithm such as a Message Digest 5 (MD 5).

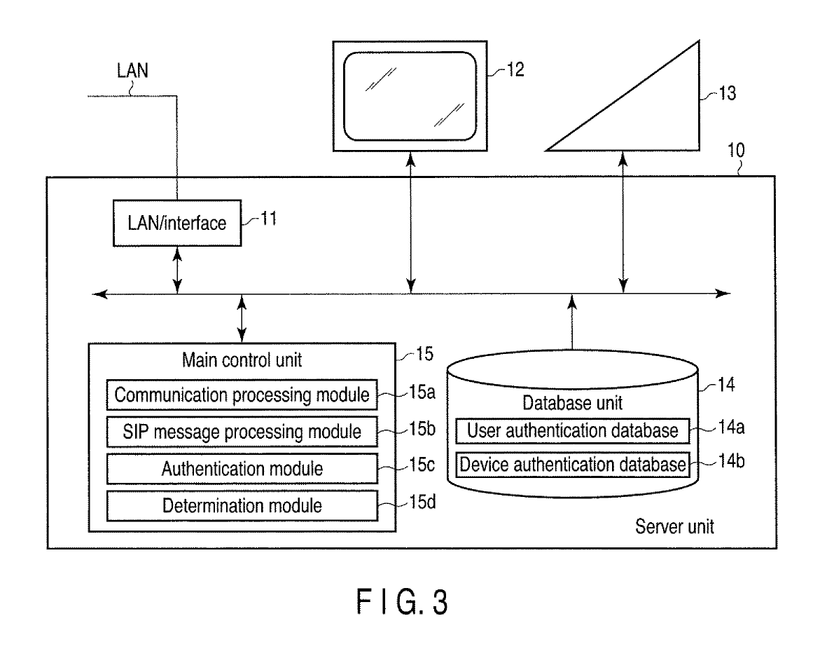

According to an embodiment, FIG. 3 is a functional block diagram depicting an embodiment of the server unit 10 of FIG. 1. The server unit 3 is provided with an interface unit 11, a display unit 12, an input and output unit 13, a database unit 14 and a main control unit 15. The interface unit 11 is connected to a LAN to perform processing of transmission and reception of packets. The display unit 12 provides a user interface together with the input and output unit 13, and constructs a graphical user interface (GUI) environment.

The database unit 14 is a storage device such as a hard disk drive, and stores a user authentication database 14a and a device authentication database 14b therein.

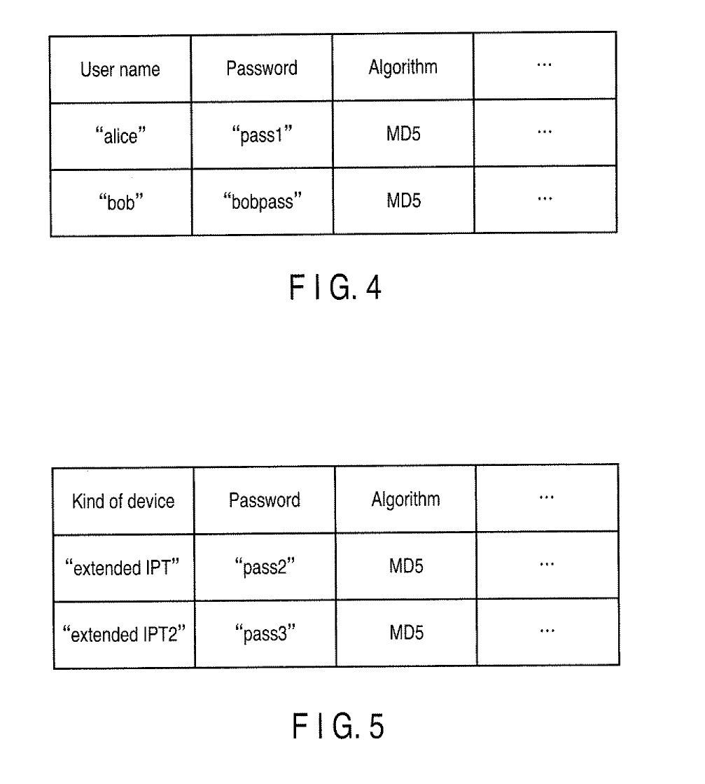

According to an embodiment, FIG. 4 is a view depicting an example of the user authentication database 14a. The database 14a is used by a framework of the existing SIP presence service, and associates each of user's names with the corresponding-password and an encryption algorithm. In the embodiment, it is assumed that a character string “pass1” is assigned to a user “alice” as a password.

According to an embodiment, FIG. 5 is a view depicting an example of the device authentication database 14b. The database 14b is newly introduced in this embodiment. That is, the database 14b is one in which a kind of a device (e.g., extension IP terminal [extended IPT]) are associated with a device password and an encryption algorithm for each IP terminal. In this embodiment, it is assumed that a password “pass2” is assigned to the IP telephone set 11. The password enables indicating that the IP telephone set 11 is an authorized IP terminal “extended IPT”. This password is stored in the memory 44 of the IP telephone set 11, and also the same character string is registered in the device authentication database 14b on a side of the server unit 10.

While the database of FIG. 5 is configured so as to define the device password for each kind of devices and authenticate the IP terminals in kind of devices, the invention is not limited to this configuration. For instance, only one password may be stored so as to authenticate only one kind of device.

While FIG. 5 has shown a status in which only the user's names (kinds of devices), the passwords and algorithms are stored in a database form as the authentication information, other items of information may be stored. For instance, different items of authentication information may associate for each item of authentication information, and different items of service permission for each user (or for each kind of devices) may be given. Further, each database of FIGS. 4 and 5 may combine, or store different items of the authentication information for each combination between a specified user and a specified IP terminal.

Now returning to FIG. 3, the main control unit 15 includes a communication processing module 15a, a SIP message processing module 15b, an authentication module 15c, and a determination module 15b as its processing functions. The communication processing module 15a conducts a function of transmitting and receiving messages via the IP network to and from the IP terminals. For instance, the module 15a transfers the SIP messages received via the IP network to the SIP message processing module 15b, and transmits the SIP messages transferred from the module 15b to the IP network. The module 15b generates and reads the SIP messages. The operations are performed in accordance with specifications of a proxy server of SIP described in RFC 3261, etc.

The authentication module 15c is called from the module 15b to operate for performing the authentication processing, and provides a function of verifying the authentication required from the IP terminal and its user. That is, the authentication module 15c transmits the challenge values to the IF terminals of the authentication request sources for message exchange in the authentication process, and verifies the response values returned against the challenge values.

The determination module 15d is called from the authentication module 15c and operates, and then, determines the results of the digest authentication on the basis of the result of the verification by the authentication module 15. That is, the determination module 15d determines whether or not what kind of permission should be given to the IP terminal of the authentication request source and the user on the basis of the results of the verification of the determination module 15d. The following will describe operations of the foregoing configuration.

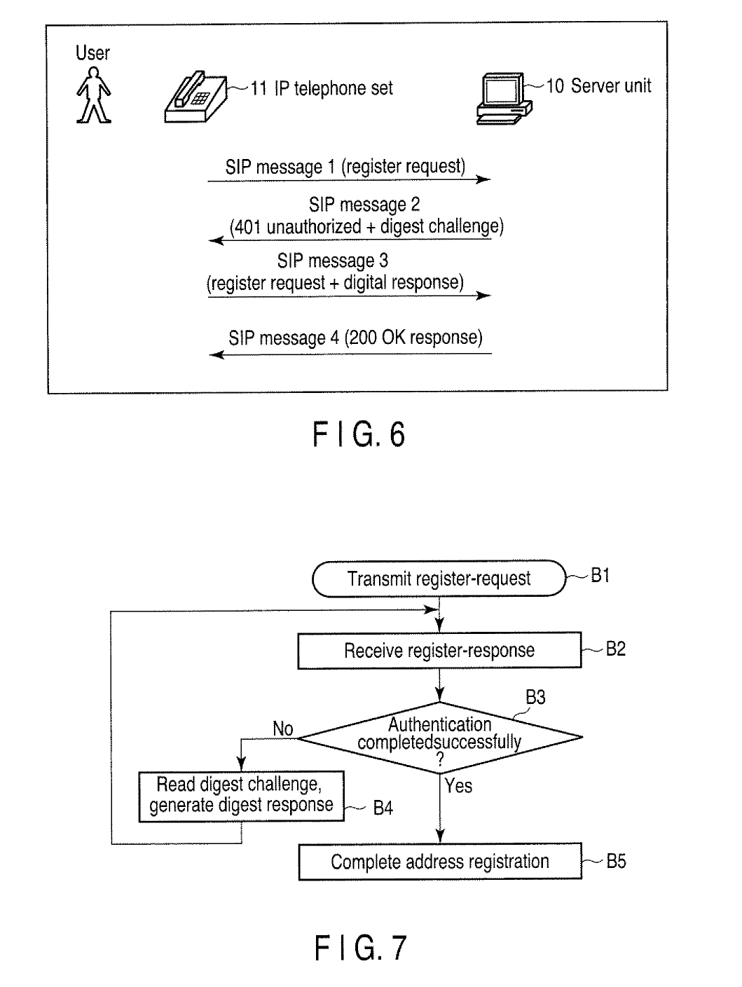

According to an example, FIG. 6 shows a view depicting a message sequence transmitted and received between an IP terminal and the server unit 10. When the user “alice” requests registration of a SIP address (alice@example.com) so as to use the IP telephone set 11, the sequence is started, and when the user “alice” and the IP telephone set 11 are authenticated by the server unit 10 and the registration of the SIP address of the user “alice” has been completed, the sequence is terminated. In the sequence, the server unit 10 registers the SIP address (alice@example.com) after authenticating the use of the IP telephone set 11 by the user “alice”. It is assumed that a domain part (a part of [@example.com]) of the SIP address is set in advance in the IP telephone set 11.

The user “alice” firstly inputs the user name from the IP telephone set 11 to request authentication. Then, in the IP telephone set 11, the SIP message processing module 42b generates a SIP message (SIP message 1) as is expressed by following.

### SIP Register Message 1

Register sip:registar.example.com SIP/2.0
Max-Forwards: 70
Via: SIP/2.0/UDP 192.168.0.101; branch=z9hG4bK74aj7
From: <sip: alice@example.com>;tag=xxxxx
To: <sip: alice@example.com>
Call-ID: 2222@192.168.0.101
CSeq: 1 REGISTER
Contact: <sip: alice@192.168.0.101>
Content-Length: 0

SIP message 1 is transmitted to the IP network via the communication processing module 42a.

The server unit 10 receives SIP message 1 by means of the communication processing module 15a. The module 15a transfers SIP message 1 to the SIP message processing module 15b. The SIP message processing module 15b reads SIP message 1 to read that SIP message 1 is an address registration request message for the use of the SIP address (alice@example.com). The module 15b requests the authentication module 15c to perform the authentication processing.

The module 15c distinguishes that SIP message 1 is a registration request of the user Alice and that it is necessary to authenticate a challenge response system using the MD 5 algorithm. However, in this stage, SIP message 1 does not include information for the authentication. Thereby, the module 15c generates a digest challenge value for executing the authentication of the MD 5 algorithm, and gives the challenge value to the SIP message processing module 15b to request generation of the SIP message.

The module 15b generates a SIP message (SIP message 2) as is expressed by following, based on the challenge value received from the authentication module 15c.

### SIP Register Message 2

SIP/2.0 401 Unauthorized
Via: SIP/2.0/UDP 192.168.0.101;

branch=z9hG4bK74aj7; received=192.168.0.100
From: <sip: alice@example.com>;tag=xxxxx
To: <sip: alice@example.com>; tag=yyyyy
Call-ID: 2222@192.168.0.101
CSeq: 1 REGISTER
Contact: <sip: alice@192.168.0.101>; expires=300
WWW-Authenticate: Digest

realm=“example.com”, nonce=“abcdef”,
algorithm=“MD5”
Content-Length: 0

SIP message 2 includes a WWW-Authenticate header, and includes a digest challenge value “abcdef” generated from the authentication module 15c in a nonce data area of the WWW-Authenticate header. SIP message 2 is transmitted from the communication processing module 15a to the IP network and is arrived at the IP terminal through routing in the IP network.

The IP telephone set 11 receives SIP message 2 by means of the communication processing module 42a. The module 42a transfers SIP message 2 to the SIP message processing module 42b. The module 42b reads SIP message 2 and reads that SIP message 2 is a request for authentication processing in order to register the SIP address.

The IP telephone set 11 displays a message, prompting the user “alice” to input a password, on the display unit 40. The password may be input in a stage for inputting the user's name. When the password is input, the authentication client module 42c calculates two digest response values in accordance with the ways (1) and (2) described as follows:

(1) The digest response value for user authentication is calculated by the MD 5 algorithm on the basis of the device password “pass” input by the user “alice” and of other pieces of SIP message information. The digest response value acquired herein is set as “qrst uvwx yz12 3456”.

(2) The digest response value for device authentication is calculated by the MD 5 algorithm on the basis of the device password “pass 2” of the IP telephone set 11 and of other pieces of SIP message information. The digest response value acquired herein is set as “qrst uvwx yz12 3456”.

To calculate the two digest response values, the same digest challenge value “abcdef” may be used. Or, the received digest challenge values may be divided into two to read them, the former value “abc” may be used as a digest challenge value for the user authentication, and the later value “efg” may be used as a digest challenge value for the device authentication of the IP telephone set 11. The authentication client module 42c notifies a digest response value “abcd efgh ijkl mnop qrst uvwx yz12 3456” in which the acquired two digest response values are put together to the SIP message processing module 42b.

The digest response value (2) acquired by the way (1) may use the digest response value for calculating another digest response value calculated by the way (2), and may notify the digest response value acquired by the way (2) to the module 42b as a whole of digest response value.

The module 42b generates a STP message (SIP message 3) as is expressed by following.

### SIP Register Message 3

Register sip:registrar.example.com SIP/2.0
Max-Forwards: 70
Via: SIP/2.0/UDP 192.168.0.101; branch=z9hG4hK74aj7
From: <sip: alice@example.com>; tag-zzzzz
To: <sip: alice@example.com>
Call-ID: 2222@192.168.0.110
CSeg: 2 REGISTER
Contact: <sin: alice@192.168.0.101>
Authorization: Digest

username=“alice”, realm=“example.com”,

nonce=“abcdef”, uri=“sip:register.example.com”,

response=“abcd efgh ijkl mnop qrst uvwx yz12 3456”
Content-Length: 0

SIP message 3 includes an Authorization header, and includes the digest response value “abcd efgh ijkl mnop qrst uvwx yz12 3456” generated from the module 42c in the response data area of the Authentication header. SIP message 3 is transmitted to the server unit 10 from the communication processing module 42a via the IP network.

The server unit 10 receives SIP message 3 by means of the communication processing module 15a. The module 15a transfers SIP message 3 to the module 15b. The module 15b reads that the SIP message is an address registration request message for the use of the SIP address (alice@example.com).

The module 15b requests the authentication module 15c to perform authentication processing for performing the authentication when the SIP address is registered. The authentication module 15c distinguishes that SIP message 3 is a registration request of the user “alice” and it is necessary to authenticate the challenge response system using the MD 5 algorithm.

The authentication module 15c starts the authentication processing of the user “alice” on the basis of the value “abcdef” that is the digest challenge value transmitted by the module 15c itself and a digest response value “abcd efgh ijkl mnop qrst uvwx yz12 3456” included in SIP message 3 received from the IP telephone set 11. More specifically, the validity of the digest response value is verified by the following three ways (A-C).

(A) [Verification of Ordinal Digest Response Values]

Verify whether or not the value calculated by means of the MD 5 algorithm from the digest challenge value “abcdef” and the password “pass1” of the user's name “alice” coincides with the digest response value “abcd efgh ijkl mnop qrst uvwx yz12 34566”.

(B) [Verification Only of the Digest Response Value Corresponding to the User Name]

Verify whether or not the value calculated by means of the MD 5 algorithm from the digest challenge value “abcdef” and the password “pass1” of the user's name “alice” coincides with an anterior half of the digest response value “abcd efgh ijkl mnop”.

(C) [Verification Only of the Digest Response Value Corresponding to Each Kind of Devices]

Verify whether or not the value calculated by means of the MD 5 algorithm from the digest challenge value “abcdef” and the device password “pass2” of the IP telephone set 11 coincides with a posterior half of the digest response value “qrst uvwx yz12 3456”.

Verification A is equivalent to the verification at the digest authentication in the SIP standards defined by REC 3261, etc. Verification B is equivalent to the verification at the digest authentication for the user authentication. Verification C is equivalent to the verification at the digest verification for the device authentication. Herein, while the verification has been performed as if only the “extended IPT” is a valid device, if there are plurality of kinds of valid devices, verification related to the devices are performed for each kind of devices.

In the sequence of FIG. 6, if the user “alice” inputs a correct password and if the IP telephone set 11 stores a valid device password, verification B and C are completed correctly (OK), and verification A results in failure (NG). The authentication module 15c notifies which of A-C has completed successfully or unsuccessfully to the determination module 15d.

The determination module 15d receives this notification and determines as follows:

(i) If verification A has been performed correctly, it is determined that the digest authentication has been performed by the terminal corresponding to standard SIP

(ii) If verification A has turned out a failure, and if verification B and C are performed correctly, it is determined that both the user and device have been authenticated correctly

(iii) If verification A and C have turned out failures, and if verification B has been performed correctly, it is determined that the user has been authenticated correctly, but the device has not been authenticated

(iv) If verification A and B have turned out failures, and if verification C has been performed correctly, it is determined that the device has been authenticated correctly, but the user has not been authenticated

(v) If all the items of verification A, B and C have turned out failures, it is determined that both the device and the user have not been authenticated.

The determination module 15d notifies the result of any one of the cases (i)-(v) to the SIP message processing module 15b. The module 15b receives the notification from the determination module 15d to conduct processing corresponding to an authentication policy of the IP communication system.

For instance, if the result of the module 15d is any one of the cases (i)-(iii), since at least the user “alice” has been authenticated, its SIP address is registered. Then, the processing module 15b generates the SIP message for notifying the fact of the success of the address registration. An example of the SIP message (SIP message 4) is expressed by following.

### SIP Register Message 4

SIP/2.0 200 OK
Via: SIP/2.0/UDP 192.168.0.101;

branch=z9hG4bK74aj7; received=192.168.0.100
From: <sip: alice@example.com>; tag-zzzzz
To: <sip: alice@example.com>; tag vvvvv
Call-ID: 2222@192.168.0.101
CSeq: 2 REGISTER

Contact: <sip: alice@192.168.0.101>;expires=300;
Content-Length: 0

SIP message 4 is given from the SIP message processing module 15b to the communication processing module 15a, and transmitted to the IP telephone set 11 via the IP network. Especially, if the result of the determination module 15d is shown by the above (ii), since the kind of the device has been authenticated correctly; it makes it possible to set so as to provide an IP telephone service which is unique to the device.

Meanwhile, if the result of the module 15d is shown by the above (iv) or (v), since the user “alice” has not been authenticated, its SIP address is not registered, and the SIP message (SIP message 4-2) is notified to the IP telephone set 11.

### SIP Register Message 4-2

SIP/2.0 403 Forbidden
Via: SIP/2.0/UDP 192.168.0.101;

branch=z9hG4bK74aj7; received=192.168.0.100
From: <sip: alice@example.com>; tag=zzzzz
To: <sip: alice@example.com>; tag=vvvvv
Call-ID: 2222@192.168.0.101
CSeq: 2 REGISTER
Contact: <sip: alice@192.168.0.101>;
Content-Length: 0

According to an embodiment, FIG. 7 shows a flowchart depicting a processing procedure of the IP telephone set 11 in the foregoing sequence. For authenticating, the IP telephone set 11 transmits the authentication request (SIP message 1) (Block B1), and receives the authentication response (SIP message 2) (Block B2). In this stage, if the authentication has been completed successfully (Yes, Block B3), the registration of the SIP address of the IP telephone set 11 is completed (Block B5). Conversely, if the authentication has turned out a failure in Block B3, the IP telephone set 11 reads the digest challenge value received from the server unit 10 to generate the digest response value, and returns SIP message 3 with the digest response value described therein to the server unit 10.

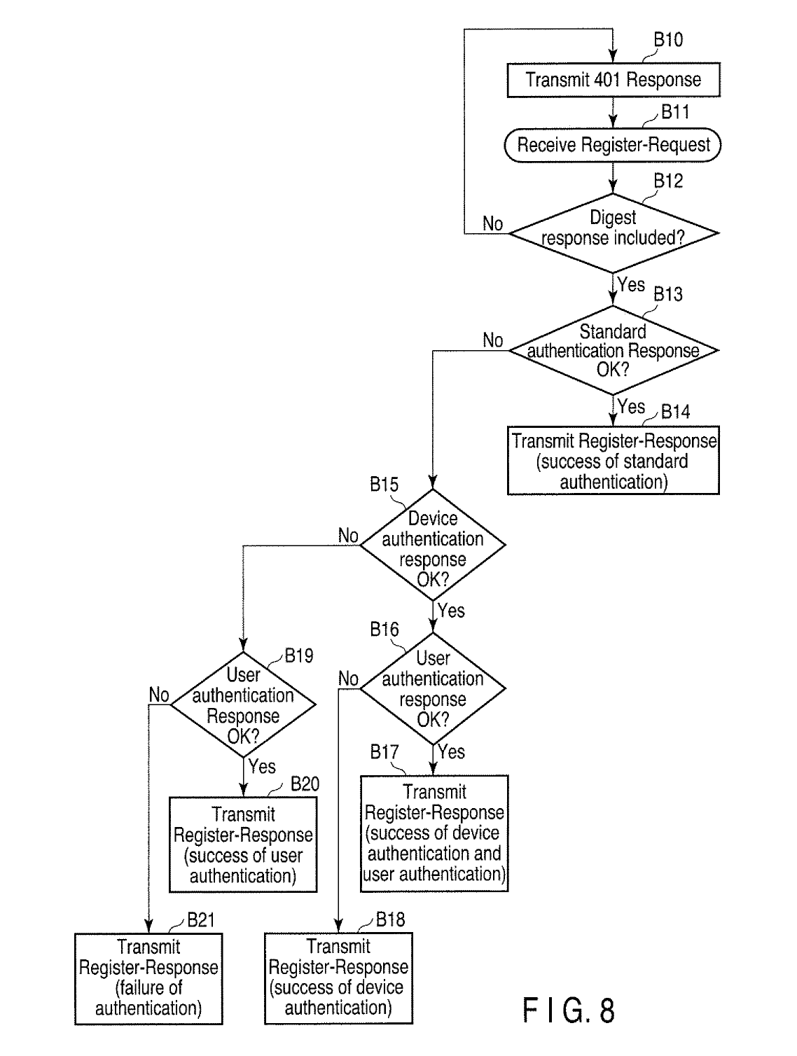

According to an embodiment, FIG. 8 is a flowchart depicting a processing procedure of the server unit 10 in the sequence of FIG. 6. The server unit 10 which has received the authentication request transmits the SIP message including a 401 response to the SIP terminal 11 (Block B10), then, waits for arrival of the SIP message including the digest response value in a loop of Block B10-Block B12. When SIP message 3 including the direct response value has arrived from the IP terminal 11, the server unit 10 determines success or failure of the standard authentication (Block B13), and then, the server unit 10 determines the foregoing determination (i) and transmits a response indicating the success of the standard authentication to the IP terminal 11 (Block 814).

If the standard authentication has not completed successfully (No, Block B13), the server unit 10 determines the success or failure of the device authentication (Block B15), and if it is determined that the device authentication has completed successfully, the server unit 10 further determines the success or failure of the user authentication (Block B16). If it is determined positively, it results in approval of the determination (ii), and the server unit 10 returns the SIP message showing the success of the authentication of both the device and the user to the SIP terminal 11 (Block B17). Of the Block B16 results in No, verification (iv) is established, and the SIP message showing the authentication only of the device is returned to the SIP terminal 11 (Block B18).

Even if the device authentication has completed unsuccessfully (No, Block B15), the server un-t 10 determines the success or failure of the user authentication (Block B19), if the user authentication has completed successfully, it results in establishment of the determination (iii), the server unit 10 returns the SIP message showing the success of the authentication only of the user to the SIP terminal 11 (Block 320). If the determination in Block 19 also results in denial, it results in the determination (v) showing that all pieces of authentication have turned out failures, the SIP message showing the fact is returned to the SIP terminal 11 (Block B21).

As mentioned above, in the embodiment, in the digest authentication which becomes necessary to register the addresses of the IP terminals, the IP communication system uses the digest challenge authentication transmitted from the server unit 10, and transmits the information in which the digest response value for the device authentication and the digest response value for the user authentication are combined with each other as the digest response value to the server unit 10. The server unit 10 uses the combined direst response value to perform both the user authentication and the device authentication.

The server unit 10 then each obtains the result of the device authentication of the IP terminal and the result of the standard authentication, and may decide appropriate access permission of system for the IP terminal and the user in accordance with the combination of the results. In this like, verifying the success or failure of the device authentication enables providing services finer than those of the existing system.

In this embodiment, both SIP message 2 including the digest challenge value and SIP message 3 including the digest response value may be used as messages which are compatible with standard SIP. That is, although these messages include not only the digest authentication information related to the users but also the digest authentication information related to the devices or the kinds of the devices, both the nonce area and the response area of these messages have forms of the messages which are compatible with SIP. Both the IP terminal and the server unit 10 have functions of reading the information in these areas. Therefore, according to the embodiment, it makes it possible to construct all the SIP messages which are closed in the frameworks of the standard SIP messages described in REC 3261, etc. Thus, the system of the embodiment may also correspond to IP terminals and a server unit which are compatible only with standard SIP. This poses advantages in an environment in which the IP terminals having the functions of this embodiment and IP terminals not having such functions coexist.

Summarizing the above description, according to the embodiment, it makes it possible to perform the device authentication in addition to the normal user authentication through the shared SIP messages by putting together while using a framework/protocol format of the digest authentication of standard SIP as it is. Thus, according to this embodiment, it makes it possible to classify each five case, namely a case of correct authentication of both users and devices, a case of authentication only of devices, a case of authentication only of users, a case of authentication as standard SIP, and a case of a failure of authentication, and give different access permission to the SIP terminals by associating with each case.

The IP terminals perform the device authentication of the IP terminals at the same time of the digest authentication for the user authentication. Thereby, since it becomes not necessary to mount, support, transmit and receive messages of a special authentication protocol for the device authentication of the IP terminals, the system may enhance efficiency of network processing.

Further, the digest authentication system using the SIP Register message which has been described in the embodiment does not inhibit operations of the normal IP terminals corresponding to the SIP protocol in IETF standards That is, the server unit 10 may give appropriate access permission to the normal IP terminals corresponding only to the STP protocol of ISEF standards and also to the IP terminals with the functions of the embodiment mounted thereon by executing the SIP Register message exchange. Therefore, the system of the embodiment is high in affinity with the standard devices corresponding to the IETF standards. As described above, the system becomes able to easily achieve the device authentication, thus, it becomes able to provide the IP communication system, the server unit, the terminal device, and the authentication method which improve the convenience in the aspect of operations.

The invention is not limited to the above mentioned embodiments. For instance, in an environment in which it is net necessary to correspond to an IP terminal and the server unit 10 which can correspond only to standard SIP, that is, in an environment in which the IP terminal having the functions of the embodiment and the IP terminal not having the functions do not coexist, it is not necessary to adhere to a SIP message format which is compatible with standard SIP. Hereinafter, other examples of the SIP messages will be described.

For instance, in SIP message 2, both the digest challenge value for the user authentication and the digest challenge value for the device authentication may be described in the SIP message expressly. An example of such a message (SIP message 2-2) is expressed by following.

### SIP Register Message 2-2

SIP/2.0 401 Unauthorized
Via: SIP/2.0/UDP 192.168.0.101;

branch=z9hC4bK74aj7; received=192.168.0.100
From: <sip: alice@example.com>; tag=xxxxx
To: <sip: alice@example.com>; tag=yyyyy
Call-ID: 2222@192.168.0.101
CSeq: 1 REGISTER
Contact: <sip: alice@192.168.0.101>; expires=300
WWW-Authenticate: Digest-double

realm=“example.com”, usernonce=“abcdef”,

devicenonce=“ghijkl”, algorithm=“MD5”
Content-Length: 0

In SIP message 2-2, it is cleared to include two values by the description of “Digest-double” in a WWW-Authenticate header, and concrete character strings are described at a digest challenge value for the user authentication (usernonce) and a digest challenge value for the device authentication (devicenonce), respectively.

Similarly, in SIP message 3, both the digest response value for the user authentication and the digest response value for the device authentication may be expressly described in the SIP message. An example of such a message (SIP message 3-2) is expressed by following.

### SIP Register Message 3-2

Register sip:registrar.example.com SIP/2.0
Max-Forwards: 70
Via: SIP/2.0/UDP 192.168.0.101; branch=z9hG4bK74aj7
From: <sip: alice@example.com>; tag-zzzzz
To: <sip: alice@example.com>
Call-ID: 2222@192.168.0.101
OSeq: 2 REGISTER
Contact: <sip: alice@192.168.0.101>
Authorization: Digest-double

username=“alice”, realm=“example.com”,

username=“abcdef”, devicenonce=“ghijkl”

uri=“sip:register.example.com”,

userresponse=“abcd efgh ijkl mnop qrst uvwx yz12 3456”

deviceresponse=“qrst uvwx yz12 3456 abcd efgh ijkl mnop”
Content-Length: 0

In SIP message 3-2, it is cleared to include two values by the description of “Digest-double” in a WWW-Authenticate header, and concrete character strings are described at a digest response value for the user authentication (userresponse) and a digest response value for the device authentication (deviceresponse), respectively.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied from a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An Internet Protocol communication system provided with a plurality of terminal devices configured to mutually communicate with one another via an IP network and a server unit which performs digest authentication in response to authentication requests transmitted from the terminal devices, wherein
the server unit comprises:
an authentication processing module which transmits challenge values to terminal devices of authentication request sources, and verifies response values returned to the challenge values; and
a determination module which determines results of the digest authentication on the basis of the results of the verification, and
at least one of the plurality of terminal devices comprises:
an authentication client module which generates the response values by using a defined algorithm in accordance with user passwords input by users, and with device passwords stored in advance, and returns the response values to the server unit.

2. The system of claim 1, wherein
the server unit comprises a user authentication database in which the user passwords are registered by associating the passwords with each user;
the authentication processing module verifies whether or not verification values, which are calculated by using a defined algorithm in accordance with user passwords of users of the terminal devices of the request sources acquired from the user authentication database and with the challenge values, coincide with the response values; and
the determination module determines success of standard digest authentication to the users of the terminal devices request sources.

3. The system of claim 2, wherein
the server unit comprises a device authentication database in which the device passwords are registered by associating the device passwords with each of the terminal devices;
the authentication processing module verifies whether or not verification values, which are calculated by using a defined algorithm in accordance with user passwords acquired from the user authentication database, with the device passwords of the terminal devices of the request sources acquired from the device authentication database, and with the challenge values, coincide with the response values; and
the determination module determines success of digest authentication to the users of the terminal devices of the request sources, and success of digest authentication to the terminal devices if the verification data coincides with the response values.

4. The system of claim 2, wherein
the response values consist of first and second values;
the authentication client module generates the first values by using the algorithm in accordance with the challenge values and the user passwords; and
generates the second values by using the algorithm in accordance with the challenge values and the device passwords;
the server unit comprises:
a device authentication database in which the device passwords are registered by associating the device passwords with each terminal device;
the authentication processing module
verifies whether or not first verification data calculated by using the algorithm in accordance with user passwords of users of the terminal devices of the request sources acquired from the user authentication database and with the challenge values coincide with the first values; and
verifies whether or not second verification data calculated by using the algorithm in accordance with device passwords of the terminals of the request sources acquired from the device authentication database and the challenge values coincide with the second values; and
the determination module determines success of digest authentication to the users of the terminal devices of the request sources if the first verification data coincides with the first values; and
determines success of digest authentication to the terminal devices of the request sources if the second verification data coincides with the second values.

5. The system of claim 1, wherein
the plurality of terminal devices form session among one another by using Session Initiation Protocol.

6. A server unit which performs digest authentication in response to authentication requests transmitted from each of a plurality of terminal devices mutually communicable via an Internet Protocol network, comprising:
an authentication processing module which transmits challenge values to terminal devices of authentication request sources and verify response values returned to the challenge values; and
a determination module which determines results of the digest authentication on the basis of results of the verification.

7. The unit of claim 6, further comprises:
a user authentication database in which the user passwords registered by associating the user passwords with each of the users, wherein
the authentication processing module verifies whether or not verification values, which is calculated by using a defined algorithm in accordance with user passwords of users of the terminal devices of the request sources acquired from the user authentication database, and with the challenge values transmitted to the terminal devices of the request sources, coincide with the response values; and
the determination module determines success of standard digest authentication to the users if the verification values coincide with the response values.

8. The unit of claim 7, further comprises a device authentication database in which the device passwords registered by associating the device passwords with each of the terminal devices, wherein
the authentication processing module verifies whether or not verification data, which is calculated by using a defined algorithm in accordance with user passwords acquired from the user authentication database, with device passwords of the terminal devices of the request sources acquired from the device authentication devices, and with the challenge values transmitted to the terminal devices of the request sources, coincide with the response values; and
the determination module determines success of digest authentication to the terminal devices of the request sources, and success of digest authentication to the terminal devices if the verification data coincides with the response values.

9. The unit of claim 77 wherein
the response values consist of first and second values;
the unit further comprises a device authentication database in which the device passwords are registered by associating the device passwords with each of the terminal devices;
the authentication processing module verifies whether or not first verification data, which 1s calculated by using the algorithm in accordance with the user passwords of the users of the device terminals of the request sources acquired from the user verification database and with the challenge values, coincides with the first values; and
verifies whether or not second verification data, which is calculated by using the algorithm in accordance with the device passwords of the terminal devices acquired from the device authentication database and with the challenge values, coincides with the second values; and
the determination module determines success of digest authentication to the users of the terminal devices of the request sources if the first verification data coincides with the first values; and determines success of digest authentication to the terminal devices of the request sources if the second verification data coincides with the second values.

10. The unit of claim 6, wherein
the plurality of terminal devices form session among one another by using Session Initiation Protocol.

11. A terminal device configured to mutually communicate with other devices via an Internet Protocol, comprising:
a transmission module which transmits an authentication request to a server unit which performs digest authentication; and an authentication client module which generates a response value by using a defined algorithm in accordance with a challenge value returned from the server unit to the authentication request, with a user password input by a user, and with a device password stored in advance and transmits the response value to the server unit.

12. The device of claim 11, wherein
the response value consists of a first and a second values,
the authentication client module generates the first value by using the algorithm in accordance with the challenge value and with the user password; and generates the second value by using the algorithm in accordance with the challenge value and the device password.

13. The device of claim 11, further comprising:
sessions which are formed among the other devices by using Session Initiation Protocol.

14. An authentication method for performing digest authentication to terminal devices connected to an internet Protocol network, comprising:
transmitting challenge values to terminals devices of authentication request sources from a server unit which performs the digest authentication;
generating response values from terminal devices which have received the challenge values by using a defined algorithm in accordance with the challenge values, with user passwords input by users, and with device passwords stored in advance;
returning the response values from the terminal devices to the server unit;
verifying the returned response values by means of the server unit; and
determining results of the digest authentication by the server unit on the basis of results of the verification.

15. The method of claim 14, wherein
the server unit
includes a user authentication database in which the user passwords are registered by associating the user passwords with each of the users;
acquires user passwords of users of terminal devices of the request sources from the user authentication database;
calculates verification values by using the algorithm in accordance the acquired user passwords and with the challenge values; and
determining success of standard digest authentication to users of the terminal devices of the request sources if the verification values coincide with the response values.

16. The method of claim 15, wherein
the server unit includes
a device authentication database in which the device passwords are registered by associating the device passwords with each of the terminal devices;
acquires device passwords of the terminal devices of the request sources from the device authentication database;
calculates verification data by using the algorithm in accordance with the acquired user passwords, with acquired device passwords, and with the challenge values; and
determining success of digest authentication to the users of the terminal devices of the request sources and success of digest authentication to the terminal devices if the verification data coincide with the response values.

17. The method of claim 15, wherein
the response values consist of first and second values,
the terminals devices which have received the challenge values
generates the first values by using the algorithm in accordance with the challenge values and with the user passwords; and
generates the second values by using the algorithm in accordance with the challenge values and with the device passwords,
the server unit includes
a device authentication database in which the device passwords registered by associating the device passwords with each of the terminal devices;
verifies whether or not first verification data, which is calculated by using the algorithm in accordance with the acquired user passwords and the challenge values, coincides with the first values;
verifies whether or not second verification data, which is calculated by using the algorithm in accordance with the device passwords acquired from the device authentication database and with the challenge values, coincides with the second values;
determines success of digest authentication to the terminal devices of the request sources if the first verification data coincides with the first values; and
determines success of digest authentication to the terminal devices of the request sources if the second verification data coincides with the second values.

18. The method of claim 14, wherein
the terminal devices forms sessions among other devices by using Session Initiation Protocol.
